(19) United States
(12) Patent Application Publication
(10) Pub. No.: US 2008/0204607 A1
(43) Pub. Date: Aug. 28, 2008

(54) COLOR IMAGE DISPLAYS

(76) Inventors: Paul HOLMES, Fife (GB); Calum Dewar, Fife (GB)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/034,231

(22) Filed: Feb. 20, 2008

(30) Foreign Application Priority Data
Feb. 22, 2007 (GB) 0703472.1

(51) Int. Cl. H04N 5/74

(52) U.S. Cl. 348/757; 348/E05.137

(57) ABSTRACT

A method of producing an image, comprises the steps of providing a beam of light comprising at least three colours in sequence during a frame period, the beam comprising a pure colour period for each colour and two or more transition periods when the beam of light changes from one colour to the next colour, and of using a modulating device so that temporal subdivisions of the beam of light are either directed to form the image or not used, accepting a image signal input including intensity values ranging from a minimum value to a maximum value for each colour, determining the total intensity of each colour from the summation of the whole of the pure colour period and the respective component from the summation of the transition periods, weighting the range of intensity values of the image signal input to the total intensity for each colour, and causing the modulating device to use the beam of light from all the transition periods when the image signal intensity value corresponds to a value between the whole of the pure colour period and the total intensity period. The length of the transition periods can be longer than the actual time taken for one pure colour to change to the next pure colour, such that the white point for sum of all transitions has the same chromaticity as the white point from normal data.

### FIELD OF THE INVENTION

The present invention relates to color image displays.

### BACKGROUND OF THE INVENTION

Modern digital display systems typically create color images by mixing the light of three primary colors, red, green and blue. The three primary colors may be mixed by displaying each color simultaneously or superimposed, or by displaying each color in turn. Providing each color is displayed quickly enough in turn the human eye perceives the three colors as a single mixed color.

This may be achieved through illuminating a spatial light modulator (SLM) such as a liquid crystal array or a micromirror display with each primary color in turn, generating the primary colors from a rotating light wheel. The color wheel comprises red, green and blue filters, so that when white light is directed upon the color wheel, red, green and blue components of the white light are directed in turn towards the modulating device.

Although called a color wheel, other forms of filter such as a cylinder or a hexagon can be used, and the filters may separate each primary color in turn either by reflecting or transmitting. Some color wheels include additional, non-primary colors, and/or clear areas that transmit white light in addition to filtered color.

In order for the displayed image to be as bright as possible, it is desirable to illuminate the modulating device for as much time as possible. For this reason, one or more of the neighboring color filters of the color wheel often directly abut each other each other with no black boundary between them. Since the beam of white light directed at the color wheel has a finite cross section with a leading edge and a trailing edge, from the time when the leading edge crosses a boundary between two neighboring color filter to the time the trailing edge crosses the boundary, the directed from the color wheel to the modulating means is composed of two primary colors. Therefore if a primary color filter has one or two abutting boundaries with the other two primary colors, that image or images for that color will not be composed purely of that primary color component will include one or both the other primary colors. This will affect the apparent color perceived by a viewer, so that the displayed color does not match that of the color of the input signal.

U.S. Pat. No. 6,445,505 (Morgan) shows a color wheel having red, green and blue filters, and a clear portion which transmits white light without any filtering. The color and intensity of each pixel is represented by assigning a number of bits to the length of time the modulating device is illuminated by red, blue, green and white light. In Morgan, the time taken for a light beam to cross the boundary between two colors is divided into two parts, the first part composed chiefly of the first color with a smaller amount of the second color, and the second part composed chiefly of the second color with a smaller amount of the first color (considering here white to be a color). Each such part is considered to count as a ‘white bit’, so that the white bits produced by the white section of the color wheel can be reduced and the white bit capability (and brightness of the image) is increased.

Of course, the light from the boundaries between colors is not white, and counting these boundary light bits as white bits can lead to color and intensity artifacts. To combat this, the eight different types of boundary bits are randomly distributed across the display, in order that the effect will be perceived as if white bits had been used. The use of the different types of boundary bits is also varied temporally. However, the color resolution of the display is reduced by the use of these boundary bits.

### OBJECT OF THE INVENTION

An object of the present invention is to increase the use of light in the color wheel while minimizing any color and/or intensity artifacts.

### SUMMARY OF THE INVENTION

According to the present invention there is provided a method of producing an image, comprising the steps of:

providing a beam of light comprising at least two colors in sequence during a frame period, comprising a pure color period for each color and a transition period when the beam of light changes from one color to the next color,
using a modulating device so that temporal subdivisions of the beam of light are either directed to form the image or not used
accepting a image signal input including intensity values ranging from a minimum value to a maximum value for each color
determining the total intensity of each color from the summation of the whole of the pure color period and the respective component from the transition period or periods
weighting the range of intensity values of the image signal input to the total intensity for each color
and causing the modulating device to use the beam of light from the transition period when the image signal intensity value corresponds to a value between the whole of the pure color period and the total intensity period.

The present invention, in contrast with U.S. Pat. No. 6,445,505 (Morgan), does not divide each boundary period into parts. Furthermore, the present invention does not use separate data bits for each of the boundary periods. Instead, all of the boundary periods in a complete cycle of the color wheel are treated as one composite white area. A single bit plane of data is used to control the SLM during this composite white area. This has the advantage of simplicity, and provides immunity against small amounts of jitter in the color wheel phase.

A beam of white light is directed onto a color wheel comprising red, green and blue filters, and a dark area that does not transmit light. The transmitted light then falls on a modulating device comprising an array of pixels which either allow the light falling on that pixel which either allows or does not allow the light falling on it to form part of the image.

### BRIEF DESCRIPTION OF THE DRAWINGS

An embodiment of the invention will now be described, given as an example and not intended to be limiting, with reference to drawings, of which

FIG. 1 shows color intensity values and time periods of the system

FIG. 2 shows further color intensity values and time periods of another aspect of the system

FIG. 3 shows a graphical representation of input and output signals of the system

FIG. 4 shows another graphical representation of input and output signals of the system.

### DESCRIPTION OF THE PREFERRED EMBODIMENT

Each pixel of a color image frame is represented by a bit value for each component color, for example 24 bits per pixel allows a graded intensity or bit value of 0-255 for each primary color. The pixel may therefore be switched on or ‘white’ so that, in the case of an LCD display, each primary color is reflected for a time period corresponding to its bit value and reflected to contribute to that pixel's color and brightness. The phrases ‘turning the pixel to white’ and ‘turning the pixel to black’ are used in the art to signify that the pixel has been turned on or off respectively (i.e. reflective and non-reflective in a reflective type modulating device), and this terminology will be employed hereafter.

The dark area of the color wheel allows a period for DC charge balancing to be carried out on the LCD device.

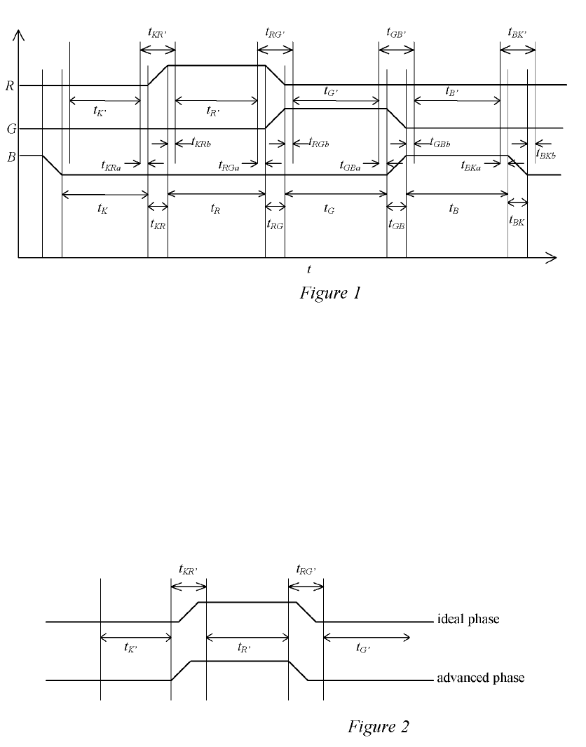

Referring to FIG. 1, for each revolution of the color wheel, the output includes time periods t_{K}, t_{R}, t_{G} and t_{B}, where light beam falls completely within the black, red, green and blue sectors and the color state is pure and the intensity is constant. Between each of these periods, there are shorter time periods t_{KR}, t_{RG}, t_{GB} and t_{BK} where the light beam crosses the boundary between the black and red sectors, the red and green sectors, and the green and blue sectors and the blue and black sectors respectively. The red (R), green (G) and blue (B) levels shown here illustrate the rise and fall and that color's light intensity between minimum (i.e. no light) and maximum (white beam fully that color's filter) values.

During t_{KR}, t_{RG}, t_{GB} and t_{BK}, the state of the light transmitted is in transition. In the black-color transitions t_{KR}, and t_{BK}, intensity of the output is changing. In the color-color transitions t_{RG} and t_{GB}, both hue and intensity are changing. The light intensity as a function of time during transitions is shown in FIG. 1 as a straight line for simplicity of illustration only—the actual waveform will depend upon the details of the illumination optics.

If the effect on the appearance of a pixel if it were to be set to white during all of the periods t_{KR}, t_{RG}, t_{GB} and t_{BK}, instead of being set to black as it is in the current system.

During t_{KR}, the light reaching the display will have the same spectrum as it will during t_{R}, (we will call this S_{R}) but the average amount of light per unit time will be lower due to the fact that the spot is partially occluded by the black sector. During the transition, the light intensity as a proportion of that during t_{R} will follow some curve beginning at 0 and ending at 1. We will denote the mean intensity factor (corresponding to the area under the curve) as q. If the curve is near-symmetrical, we would expect q to be close to 0.5, but we do not assume that it will equal that value.

If each transition period is transition period is tₜᵣ, the integrated light throughput h_{KR} is;

h_{KR}=tₜᵣqS_{R}

The transition curve during t_{RG} is the same shape as that for t_{KR}. During this transition, the mean intensity for green is q. Wherever and whenever light is not passing through the green filter, it will be passing through the red one, so the mean red intensity is 1−q. Integrated light throughput on this transition is therefore;

h_{RG}=tₜᵣ(1−q)S_{R}+qS_{G})

and similarly for the green-blue and blue-black boundaries the integrated light throughput are respectively

h_{GB}=tₜᵣ(1−q)S_{G}+qS_{B})

h_{BK}=tₜᵣ((1−q)S_{B}

The total light throughput during these to the transition periods is therefore

h_{RG}+h_{GB}+h_{BK}=tₜᵣ(S_{R}+S_{G}+S_{B})

In order to generate a white light component the spectra from the three filters must be weighted to account for the amplitudes and wavelengths transmitted by each filter, expressed as a pure-color time, t_{R}, t_{G} and t_{B} for the system. The total light throughput during the transition periods, will be an unweighted mean of the spectra, which will not be the same as that white light generated by the system using light transmitted purely from each filter in turn unless the three colored sectors are equally sized. Uncorrected, this could lead to a chromatic shading artifact at the point in a fade where the transition bit changes state.

As previously described, the operation of the modulating device and the color wheel is synchronized so that pixels are correctly switched to black and white when each primary color is directed at them in order to recreate a full color image. However, the rotation of the color wheel may vary and not be precisely in phase with the operation of the modulating device. This phenomenon and its effects is known as ‘jitter’. In a system which does not use the light from the color wheel during the transition periods, the modulating device's pixels may be switched to black either side of each transition period for a sufficient time that the phase difference does not affect the image display. However, in the present system where the transition light is used, any jitter will reduce the strength of red or blue light in the transition sum, depending on whether the color wheel phase shift is ahead of or behind the modulating device.

Referring to FIG. 1, longer transition time periods t_{KR′}, t_{RG′}, t_{GB′} and t_{BK′} which extend either side of t_{KR}, t_{RG}, t_{GB} and t_{BK} may be used, with the periods where no light, or red, green and blue light is applied to the modulating device t_{K′}, t_{R′}, t_{G′} and t_{B′} being correspondingly shorter. Each extended transition time is derived by adding pre- and post-extension periods, so for example;

t_{KR′}=t_{KRa}+t_{KR}+t_{KRb}

The light throughputs for these new transition periods will be

h_{KR′}=tₜᵣqS_{R}+t_{KRb}S_{R}

h_{RG′}=t_{RGa}S_{R}+tₜᵣ(1−q)S_{R}+tₜᵣqS_{G}+t_{RGb}S_{G}

h_{GB′}=t_{GBa}S_{G}+tₜᵣ(1−q)S_{G}+tₜᵣqS_{B}+t_{GBb}S_{B}

h_{BK′}=t_{BKa}S_{B}+tₜᵣ(1−q)S_{B}

The total red component from these four transition period light throughputs (i.e. summing the red component terms that appear in the expressions for h_{KR′} and h_{RG′}) is therefore

h_{TR}=(tₜᵣ+t_{KRb}+t_{RGa})S_{R}

and similarly for the green and blue components

h_{TR}=(tₜᵣ+t_{RGb}+t_{GBa})S_{G}

h_{TG}=(tₜᵣ+t_{GBb}+t_{BKa})S_{B}

The spectra of the summed transition bit is therefore

h_{KR′}+h_{RG′}+h_{GB′}+h_{BK′}=(tₜᵣ+t_{KRb}+t_{RGa})S_{R}+(tₜᵣ+t_{RGb}+t_{GBa})S_{G}+(tₜᵣ+t_{GBb}+t_{BKa})S_{B}

The white point for normal data (falling in the time periods t_{R′, t}_{G′} and t_{B}) is determined by the spectra from the three filters weighted in proportion to the color times t_{R′}, t_{G′} and t_{B′}. The summed white point of the transition periods is a weighted mean of the spectra, and can be made the same as for the normal data by ensuring the ratios of the normal time periods and the ratios of the transition time periods are equivalent;

t_{R′}:t_{G′}:t_{B′}::(tₜᵣ+t_{KRb}+t_{RGa}):(tₜᵣ+t_{RGb}+t_{GBa}):(tₜᵣ+t_{GBb}+t_{BKa})

That is, by adjusting the extension periods the white balance of the transition bit can be matched to the normal data and chromatic shading artifacts are avoided.

Referring to FIG. 2, the upper signal labeled ideal phase shows a red light output produced by a color wheel that is perfected synchronized with the modulating device. The lower signal labeled advanced phase shows a red light output produced by a color wheel that is ahead of the modulating device by a time period Δt. It will be seen that the red throughput in period t_{KR′} is increased and that in period t_{RG′} is reduced. The red throughput in t_{R′}, during which the red data bits are rendered, is unaffected, as the light function is flat in that region. Furthermore, since the entire red pulse (including transitions) has not changed in size, the increase in red throughput in t_{KR′} must be matched exactly by the decrease in red throughput in t_{RG′}. If the same bit data is used in t_{KR′} and t_{RG′}, the red throughput of that bit will not be affected by the jitter provided that the phase shift of the color wheel does not exceed the extensions of the transition time periods, that is;

−t_{KRa}≦Δt≦t_{KRb}

and

−t_{GBa}≦Δt≦t_{RGb}

Similarly, if the same bit data is t_{KR′} and t_{RG′} is also used in t_{GB′}, and t_{BK′}, then provided that the conditions

−t_{GBa}≦Δt≦t_{GBb}

and

−t_{BKa}≦Δt≦t_{BKb}

are also met, the image will not be affected by the jitter.

As previously discussed, each primary color has a bit value 0-255. The highest level of red (level 255) will have a total duration of t_{R′}, all fully contained within the red sector, so that a single unit of red will have throughput given by

h_{R}=t_{R′}S_{R}/255

Since the red weighting for the transition bit is h_{TR}=(tₜᵣ+t_{KRb}+t_{RGa})S_{R} the equivalent red level l_{TR} of the transition bit is

$$\begin{matrix} {l}_{TR} = {h}_{TR} / {h}_{R} \\ = 255 ( {t}_{tr} + {t}_{KRb} + {t}_{RGa} ) / {t}_{R}\end{matrix} ,$$

Similarly for the green and blue levels

l_{TG}=255(tₜᵣ+t_{RGb}+t_{GBa})/t_{G′}

l_{TB}=255(tₜᵣ+t_{GBb}+t_{BKa})/t_{B′}

Processing of the data begins with a comparison of each of the color channels with its own threshold

d_{pR}=max(g_{R}d_{inR}−l_{TR},0)

d_{pG}=max(g_{G}d_{inG}−l_{TG},0)

d_{pB}=max(g_{B}d_{inB}−l_{TB},0)

d_{pMin}=min(d_{pR},d_{pG},d_{pB})

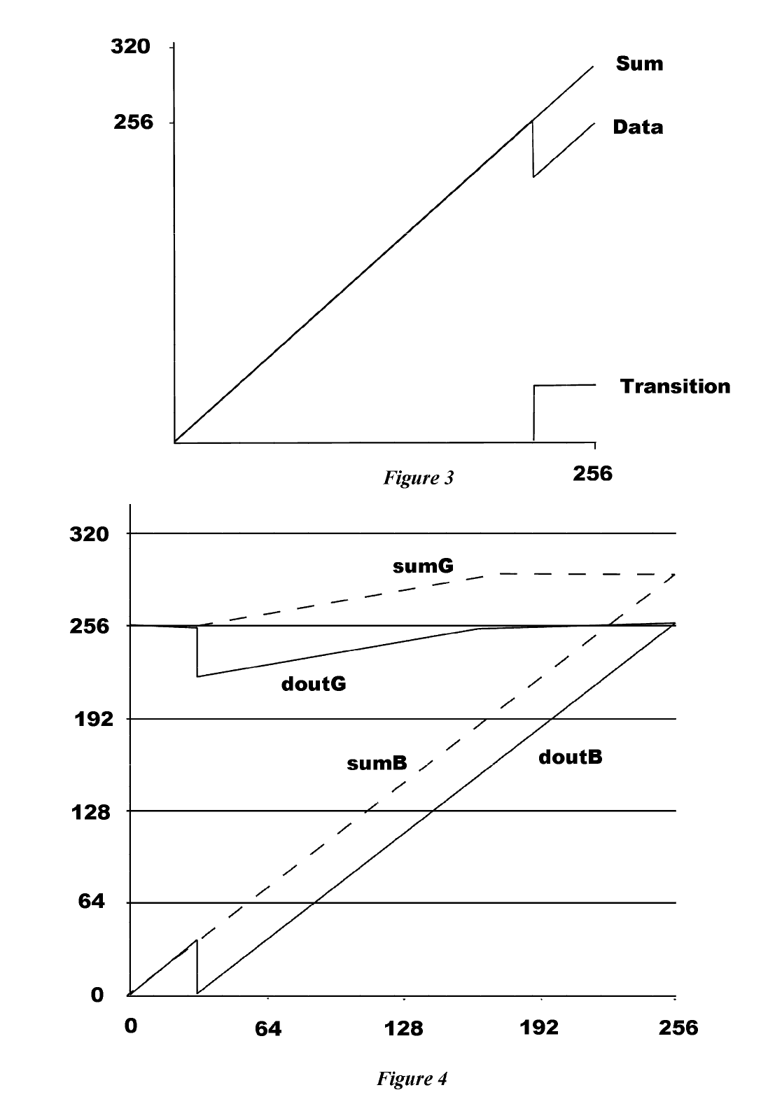

Referring to FIG. 3, a gray scale in which just one color channel (say red) is shown. The value l_{TR} has been set at 45. Looking first at the color channel data, output values have been scaled by a factor g_{aR} given by

g_{R}=(255+l_{TR})/255≈1.176

g_{aR}=1+d_{pMin}(g_{G}−1)/255

to give us a scaled value d_{sR}

d_{sR}=g_{aR}d_{inR}

Equivalent values are also derived for the other two channels.

There are situations when one color channel is much brighter than the others. In order for red output to climb above 255, the transition bit must be turned on when d_{sR} exceeds 255; there are other situations where it could be turned on. The transition bit can be turned on whenever d_{sR} is at least as large as l_{TR}, and the red data decremented by l_{TR} to maintain a smooth red response. Any residual error in level matching is less visible in a high-intensity background, so turning the transition bit on at such a low level is not always desirable.

It can be said that turning on the transition bit is desirable (T_{d}) when any data channel exceeds 255

T_{d}=(d_{sR}>255)v(d_{sG}>255)v(d_{sB}>255)

and permissible (Tₚ) when all data channels exceed their transition bit equivalents

Tₚ=(d_{sR}≧l_{TR})̂(d_{sG}≧l_{TG})̂(d_{sB}≧l_{TB})

Where it is necessary to minimize the visibility of any mismatches, in particular for demonstration and production, a ‘cautious’ approach will turn on the transition bit where it is both permissible and desirable. An ‘eager’ approach, where the transition bit is turned on whenever it is permissible will make mismatches, where they exist, maximally visible, but may be advantageously used during system set-up while parameters are being tuned. In the cautious approach we define

T=T_{d}̂Tₚ

and in the alternative, eager, approach we define

T=Tₚ

If T is true, the transition bit will be switched on, otherwise it will be switched off.

If the scaled data for one channel (say, green) exceeds 255, but the transition bit cannot be turned because one of the other channels (say, blue) is too low, then the red channel must be limited or clipped to no more than 255. A discontinuity would be produced in a fade if the clipping or red were to be suddenly removed when the blue channel changed from just below l_{TB} to so clipping must is phased out gradually. This will be called ‘soft clipping’.

To achieve soft clipping, high threshold parameters l_{HR}, l_{HG} and l_{HB} are defined for the three channels. From these, weighting factors w_{R}, w_{G} and w_{B} are calculated;

$$\begin{matrix}{w}_{R} = 0 & for {d}_{sR} < {l}_{TR} \\ = ( {d}_{sR} - {l}_{TR} ) / ( {l}_{HR} - {l}_{TR} ) & for {l}_{TR} \leq {d}_{sR} \leq {l}_{HR} , and \\ = 1 & for {d}_{sR} > {l}_{TR} \end{matrix}$$

$$\begin{matrix}{w}_{G} = 0 & for {d}_{sG} < {l}_{TG} \\ = ( {d}_{sG} - {l}_{TG} ) / ( {l}_{HG} - {l}_{TG} ) & for {l}_{TG} \leq {d}_{sG} \leq {l}_{HG} , and \\ = 1 & for {d}_{sG} > {l}_{TG}\end{matrix}$$

$$\begin{matrix}{w}_{B} = 0 & for {d}_{sB} < {l}_{TB} \\ = ( {d}_{sB} - {l}_{TB} ) / ( {l}_{HB} - {l}_{TB} ) & for {l}_{TB} \leq {d}_{sB} \leq {l}_{HB} , and \\ = 1 & for {d}_{sB} > {l}_{TB}\end{matrix} \\$$

A final weighting factor wₘᵢₙ is simply the minimum of the other three:

wₘᵢₙ=min(w_{R},w_{G},w_{B})

Considering two potential output values for the red channel, a first value, a_{R}, is to be used when the transition bit is switched off, and a second, b_{R}, is to be used when the transition bit is on;

a_{R}=min(d_{sR},255)

b_{R}=d_{sR}wₘᵢₙ+a_{R}(1−wₘᵢₙ)−l_{TR}

The final output value for the red data channel is

d_{outR}=a_{R} when T is false, i.e. when the transition bit is off, and
d_{outR}=b_{R} otherwise.

Equivalent values a_{G}, b_{G}, d_{outG}, a_{B}, b_{B} and d_{outB} are computed in the same way for the other two channels.

Referring to FIG. 4, the summed green and blue outputs are represented by dotted lines labeled sumG and sumB respectively, while the green and blue components from the pure sectors of the color wheel (i.e. without the transitional bit) are represented by full lines labeled doutG and doutB respectively (the red channel is not shown in this figure, but follows the same path as green outputs). In this example, the total output fades from pure yellow (255, 255, 0) at the left of the graph to white (255, 255, 255) at the right. Implementing the soft clipping strategy described above, the transition bit is turned on early in the fade (as soon as blue reaches l_{TB}), but the green channel is adjusted downwards to avoid a discontinuity. As blue increases, green is gradually brought up from its clipped level to its full scaled value d_{sG}.

Although the system described here uses a color wheel having three color sectors and a black sector, the concepts described here could be implemented in other systems using a color wheel with different arrangements and/or numbers of colors. Further, although each color channel here is defined using an 8 bit intensity value, the system could be adapted to other digital color representations.

Alternative embodiments using the principles disclosed will suggest themselves to those skilled in the art upon studying the foregoing description and the drawings. It is intended that such alternatives are included within the scope of the invention, which is limited only by the claims.

What I claim is:

1. A method of producing an image, comprising the steps of:
providing a beam of light comprising at least three colors in sequence during a frame period, comprising a pure color period for each color and two or more transition periods when the beam of light changes from one color to the next color,
using a modulating device so that temporal subdivisions of the beam of light are either directed to form the image or not used
accepting a image signal input including intensity values ranging from a minimum value to a maximum value for each color
determining the total intensity of each color from the summation of the whole of the pure color period and the respective component from the summation of the transition periods
weighting the range of intensity values of the image signal input to the total intensity for each color
and causing the modulating device to use the beam of light from all the transition periods when the image signal intensity value corresponds to a value between the whole of the pure color period and the total intensity period.

2. A method according to claim 1, wherein the length of the transition periods are longer than the actual time taken for one pure color to change to the next pure color, such that the white point for sum of all transitions has the same chromaticity as the white point from normal data.

3. A method according to claim 1, wherein all transition periods are longer than the actual time taken for one pure color to change to the next pure color, such that variations in the start time and end time as one color changes to the next color are accommodated.

4. A method according to claim 1, wherein the modulating device is caused to use the beam of light from the transition period but the pure color period is reduced so that summation of the pure color period used and the respective component from the transition period or periods is less than the corresponding image signal intensity value.
